(19) United States
(12) Patent Application Publication
(10) Pub. No.: US 2007/0043881 A1
(43) Pub. Date: Feb. 22, 2007

(54) DATA BUS MONITORING AND CONTROLLING SYSTEM AND METHOD

(76) Inventor: Li-Dong Li, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,164

(22) Filed: Mar. 9, 2006

(30) Foreign Application Priority Data
Aug. 18, 2005 (CN) 200510036736.5

(51) Int. Cl. G06F 3/00

(52) U.S. Cl. 710/1

(57) ABSTRACT

A data bus monitoring and controlling system is provided for monitoring and controlling a data bus. The data bus interconnects a controlling unit and a video/audio unit. The data bus monitoring and controlling system includes a reading module for reading information transmitted over the data bus, and a translating module for translating the information read from the data bus into readable information. Related data bus monitoring and controlling systems and methods are also provided.

### FIELD OF THE INVENTION

This invention relates to data bus monitoring and controlling systems and methods and, more particularly, to a monitoring and controlling system and a method for monitoring and controlling a data bus of video/audio equipment.

### DESCRIPTION OF RELATED ART

In recent years, video/audio equipment for recording and/or reproducing video/audio information has become widespread. In order to provide compact video/audio equipment, manufacturers adopt modularized video/audio units during manufacturing to ensure essential functions, such as servo controlling and decoding. System functions, such as stopping a medium or fast-forwarding the medium, are provided by separated controlling units like micro control units (MCUs). The controlling units communicate with the video/audio units based on a communication protocol, such as Inter-Integrated Circuit (I2C), or Serial Peripheral Interface (SPI), to control the video/audio units to perform specific tasks.

In order to develop video/audio equipment incorporating the modularized video/audio unit, it is desirable to know how modularized video/audio units behave and cooperate with other components of the video/audio equipment. One important aspect of the video/audio equipment that is desirable to know is the nature of communication between the controlling unit and the video/audio unit. Some bus monitor devices, such as wave runners and logic analyzers, read data transmitted on the bus and output waveforms or machinery codes, such as binary codes, and hexadecimal codes. However, these waveforms and machinery codes are hard to read and understand by users.

Therefore, a data bus monitor system which is capable of outputting more readable information is desired.

### SUMMARY OF THE INVENTION

A data bus monitoring and controlling system is provided for monitoring and controlling a data bus. The data bus interconnects a controlling unit and a video/audio unit. The data bus monitoring and controlling system includes a reading module for reading information transmitted over the data bus, and a translating module for translating the information read from the data bus into readable information.

A data bus monitoring and controlling method includes the following steps: reading information from a data bus interconnecting a controlling unit and a video/audio unit; and translating the information read from the data bus into readable information.

A data bus monitoring and controlling method includes the following steps: receiving information from a data bus interconnecting a controlling unit and a video/audio unit, the received information including first controlling commands transmitted from the controlling unit to the video/audio unit, and status information transmitted from the video/audio unit to the controlling unit; and translating the received information into readable information.

Other advantages and novel features will become more apparent from the following detailed description of preferred embodiments when taken in conjunction with the accompanying drawings, in which:

### BRIEF DESCRIPTION OF DRAWINGS

FIG. 1 is a block diagram showing working environment of a data bus monitoring and controlling system in accordance with a preferred embodiment;

FIG. 2 is a schematic diagram of a interface circuit in accordance with a preferred embodiment;

FIG. 3 is a block diagram of the data bus monitoring and controlling system in accordance with a preferred embodiment;

FIG. 4 is a schematic diagram showing an exemplary user interface of the data bus monitoring and controlling system of FIG. 1;

FIG. 5 is a flow chart illustrating a first working procedure of a data bus monitoring and controlling method in accordance with a preferred embodiment; and

FIG. 6 is a flow chart illustrating a second working procedure of a data bus monitoring and controlling method of FIG. 5.

### DETAILED DESCRIPTION

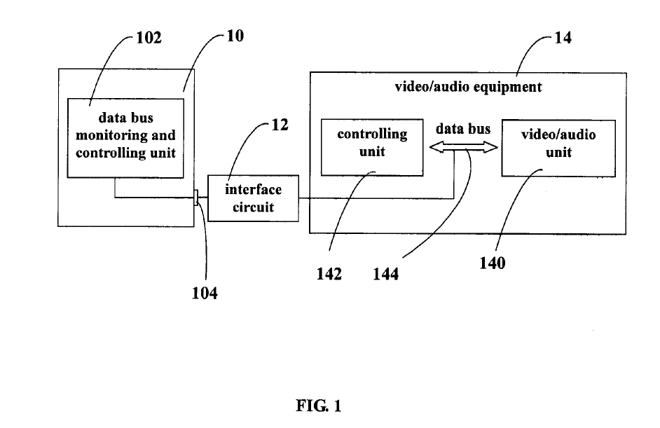

Referring to FIG. 1, a data bus monitoring and controlling system 10 connects to video/audio equipment 14 via an interface circuit 12.

The video/audio equipment 14 includes a video/audio unit 140, a controlling unit 142, and a data bus 144 for interconnecting the video/audio unit 140 and the controlling unit 142. The video/audio unit 140 is provided for performing servo control and decoding function. The controlling unit 142 transmits first controlling commands over the data bus 144 to the video/audio unit 140 and receives status information from the video/audio unit 140. All data transmitted over the data bus 144 between the video/audio unit 140 and the controlling unit 142 is hereinafter referred to as monitored information. The data bus 144 can be a communication channel, a data highway or a pathway of any form, such as an Inter-Integrated Circuit (I2C), a Serial Peripheral Interface (SPI), and other specific bus developed by manufacturers of the video/audio unit 140. In this preferred embodiment, it is presumed that the data bus 144 includes a data line for transmitting data, and a clock line for transmitting clock signals. The clock line is under the control of a transmitting station (also called a master station) that is provided for transmitting data to a receiving station (also called a slave station). The transmitting station generates clock signals on the clock line to control a start and an end of a data transmission procedure.

The data bus monitoring and controlling system 10 includes a data bus monitoring and controlling unit 102, and an input and output port 104. The input and output port 104 is a parallel port and connects to the interface circuit 12. The data bus monitoring and controlling unit 102 is provided for reading the monitored information from the data bus 144 in a monitoring mode, and sending second controlling commands to the data bus 144 to control the video/audio unit 140 to perform specific operations in a controlling mode.

The interface circuit 12 is used for connecting the input and output port 104 to the data bus 144. The interface circuit 12 receives the monitored information from the data bus 144 and transmits the monitored information to the input and output port 104. On the other hand, the interface circuit 12 receives the second controlling commands from the input and output port 104 and transmits the second controlling commands to the data bus 144.

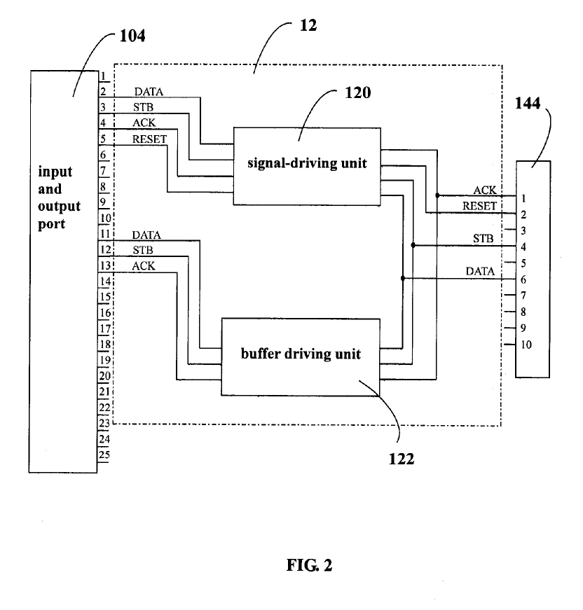

Referring to FIG. 2, the interface circuit 12 interconnects the input and output port 104 and the data bus 144. The input and output port 104 includes a plurality of pins. In this preferred embodiment, a first group of pins 2, 3, 4 and 5 of the input and output port 104 is configured as input pins, while a second group of pins 11, 12 and 13 of the input and out put port 104 is configured as output pins. The first group of pins 2, 3, 4 and 5 of the input and out put port 104 connects respectively to a data line (DATA), a clock line (STB), an acknowledge line (ACK), and a reset line (RESET). The second group of pins 11, 12 and 13 of the input and out put port 104 connects respectively to a data line (DATA), a clock line (STB), and an acknowledge line (ACK).

The data bus 144 includes a plurality of pins. A group of pins 1, 2, 4 and 6 of the data bus 144 is configured as both input and output pins. The group of pins 1, 2, 4 and 6 of the data bus 144 connects respectively to the acknowledge line (ACK), the reset line (RESET), the clock line (STB), and the data line (DATA).

The interface circuit 12 includes a signal-driving unit 120 and a buffer driving unit 122, and a plurality of signal lines for connecting the pins of both the input and output port 104 and the data bus 144. The signal-driving unit 120 is provided for receiving the monitored information from the data bus 144 and driving the monitored information to be transmitted to the input and output port 104. For example, the signal-driving unit 120 is a triode. The buffer driving unit 122 is provided for receiving the second controlling commands from the input and output port 104 and transmitting the second controlling commands to the data bus 144. The buffer driving unit 122 can be in the same structure with the signal-driving unit 120, or a signal buffer circuit.

In the monitoring mode, the data bus monitoring and controlling unit 102 reads information on the communication between the controlling unit 142 and the video/audio unit 140 from the data bus 144. The controlling unit 142 is in control of the clock line to produce clock signals that control the start and the end of the communication between the controlling unit 142 and the video/audio unit 140 via the data bus 144. Thus, the clock line connects the pin 3 of the input and output port 104 is under the control of the controlling unit 142 of the video/audio equipment 14. That is, a start and an end of data transmission from the data bus 144 to the input and output port 104 is under the control of the controlling unit 142. In the controlling mode, the data bus monitoring and controlling unit 102 serving as a controlling unit like the controlling unit 142 sends the second controlling commands to the video/audio unit 140 over the data bus 144. Thus, the data bus monitoring and controlling unit 102 is in control of the clock line connecting the pin 12 of the input and output port 104 to produce clock signals that control a start and an end of data transmission from the input and output port 104 to the data bus 144.

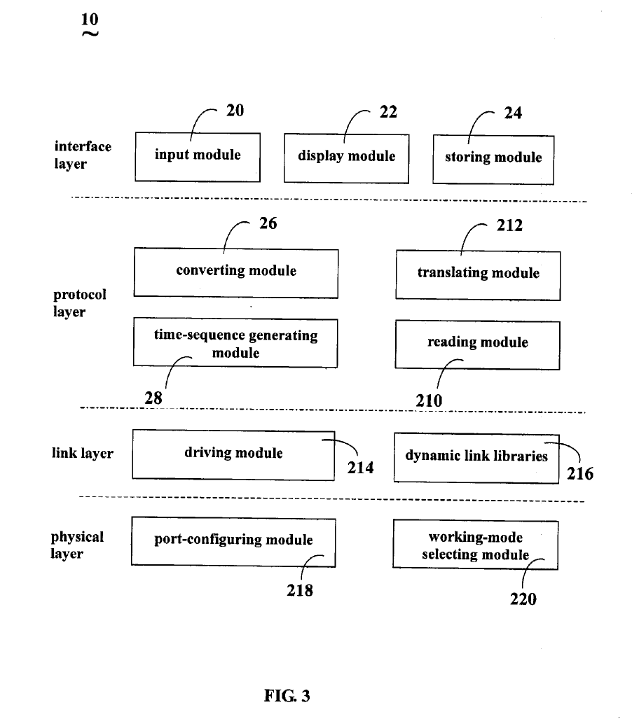

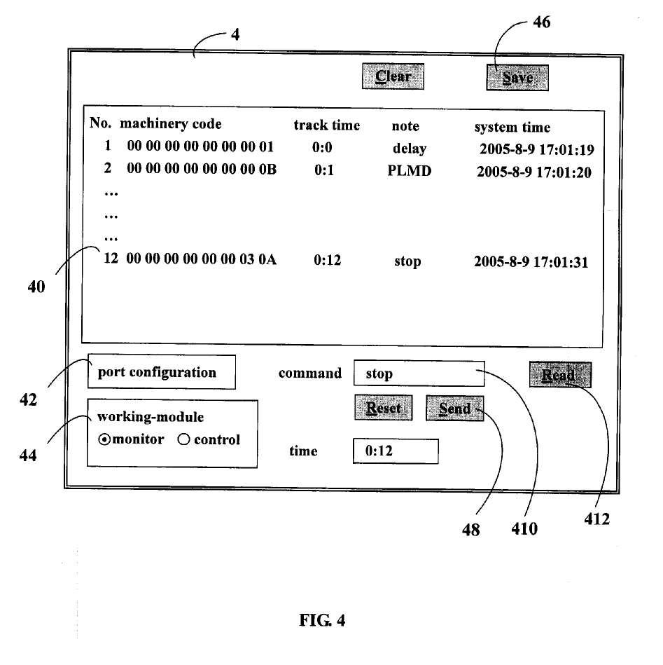

Referring to FIG. 3, the data bus monitoring and controlling unit 102 includes an interface layer, a protocol layer, a link layer and a physical layer. The interface layer provides a graphic user interface 4 as illustrated in FIG. 4, and includes an input module 20, a display module 22, and a storing module 24. The input module 20 is provided for receiving input commands from an input terminal (not shown). For example, an input field 410 is provided for entering a controlling command. An input command that is clicking the “Send” button 48 activates the transmission of the second controlling commands from the input and output port 104 to the data bus 144. An input command that is clicking the “Read” button 412, which is called a read command, activates the transmission of the monitored information from the data bus 144 to the input and output port 104. The display module 22 is used for displaying the data reading from the data bus 144. The displayed information is illustrated in a form 40. The storing module 24 is used for storing the data reading from the data bus 144. Clicking the “Save” button 46 can activate the storing operation.

The protocol layer includes a converting module 26, a time-sequence generating module 28, a reading module 210, and a translating module 212. The converting module 26 is used for converting the input commands received from the input module 30 into the second controlling commands in a predetermined format that can be recognized by the video/audio unit 140. The input commands are identical to what the controlling unit 142 generates and sends to the video/audio unit 140. For example, the input command can be entered through the input field 410, and in a readable language, for example, a command “stop” entered in the input field 410. The time-sequence generating module 28 is used for generating time-sequences that are suitable for being transmitted by the input and output port 104, based on the second controlling commands. The reading module 210 is used for starting a data reading procedure when the “Read” button is clicked, and receiving the monitored information from the input and output port 104. The translating module 212 is used for translating the monitored information into more readable information, such as a human oriented language.

The link layer includes a driving module 214 and dynamic link libraries 216. The dynamic link libraries 216 provide a function of communicating with the input and output port 104 to force the input and output port 104 to perform specific tasks. The driving module 214 is capable of calling the dynamic link libraries 216 to drive the input and output port 104 to receive the monitored information from or send the second controlling commands to the data bus 144.

The physical layer includes a port-configuring module 218 and a working-mode selecting module 220. The port-configuring module 218 is provided for configuring the input and output port 104. Such configuration includes selecting an available port of the data bus monitoring and controlling system 10 as the input and output port 104, and selecting an appropriate port type for the input and output port 104. The port types include standard parallel port (SPP), extended capabilities port (ECP), etc. Clicking on the “port configuration” button 42 activates a configuration operation. The working-mode selecting module 220 is used for selecting one mode of the monitoring mode and the controlling mode as a current mode. A selecting operation is made by clicking on one of the radio buttons of the dialog form 44.

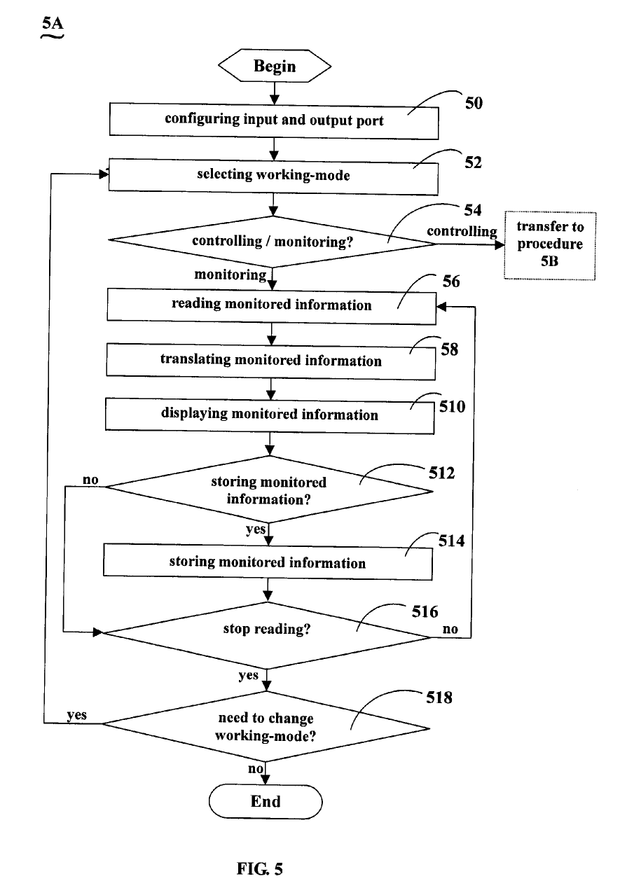

Referring to FIG. 5, a first working procedure 5A of a data bus monitoring and controlling method in accordance with a preferred embodiment is illustrated. Firstly, in step 50, a user configures the input and output port 104. In step 52, the user selects one mode of the monitoring mode and the controlling mode as the current mode. In step 54, a determination is made based on the step 52. If the current mode is the controlling mode, the procedure 5A transfers to a second working procedure 5B. If the current mode is the monitoring mode, the reading module 210 starts a reading procedure to receive information on communication upon receiving the read command from the input module 22 (step 56). Then, in step 58, the translating module 212 translates the monitored information received from the data bus 144 into more readable information to be sent to the display module 22. The display module 22 displays the readable information on a display terminal (step 510). In step 512, the displayed information is determined whether to be stored. If an input command indicating a storing operation is received, such as a click on the “Save” button 46, the storing module 24 stores the displayed information to a memory device (step 514). Then, a determination is made to determine whether the reading procedure is to be stopped (step 516). If an input command indicating stopping the reading procedure is received, such as a click on the “Read” button 412, the procedure 5A transfers to the step 518, otherwise, the procedure 5A returns to the step 56. In the step 518, a determination is made to determine whether it is needed to change the current mode. If an input command indicating to change the current mode to the other mode is received, such as a click on the other one radio button of the dialog form 44, the procedure 5B goes back to the step 52.

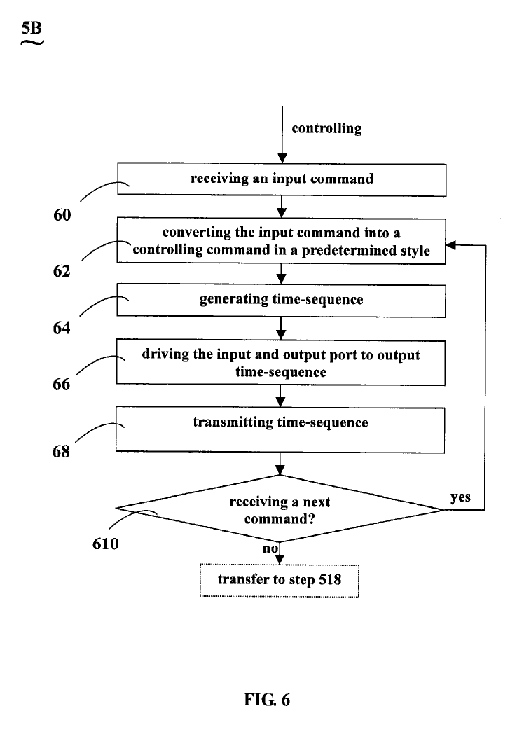

Referring also to FIG. 6, the second working procedure 5B of the data bus monitoring and controlling method of FIG. 5 is illustrated. Firstly, in step 60, the input module receives an input command from an input terminal. Then, in step 62, the converting module 26 converts the input command received through the input module 30 into a controlling command in a predetermined format that can be recognized by the video/audio unit 140. In step 64, the time-sequence generating module 28 generates time-sequences that are suitable for being transmitted by the input and output port 104, based on the second controlling command. In step 66, the driving module 214 calls the dynamic link libraries 216 to drive the input and output port 104 to output the time-sequences. Then, in step 68, the time-sequences are transmitted to the data bus 144 via the interface circuit 12. In step 610, a determination is made to determine whether a next command is received. If the next command is received, the procedure 5B returns to the step 62. Otherwise, the procedure 5B proceeds to the step 518.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A data bus monitoring and controlling system, comprising:
a reading module for reading information transmitted over a data bus interconnecting a controlling unit and a video/audio unit; and
a translating module for translating the information read from the data bus into readable information.

2. The data bus monitoring and controlling system as claimed in claim 1, wherein the readable information is a human oriented language.

3. The data bus monitoring and controlling system as claimed in claim 1, further comprising an input port connected to the data bus.

4. The data bus monitoring and controlling system as claimed in claim 3, wherein the input port is a parallel port having a plurality of pins, and the input port is connected to the data bus via an interface circuit.

5. The data bus monitoring and controlling system as claimed in claim 1, further comprising an input module for receiving an input command, a converting module for converting the input command into a controlling command in a predetermined format, and an output port for transmitting the controlling command to the data bus to control the video/audio unit.

6. The data bus monitoring and controlling system as claimed in claim 5, further comprising dynamic link libraries, and a driving module for calling the dynamic link libraries to drive the output port to output the controlling command.

7. The data bus monitoring and controlling system as claimed in claim 1, further comprising a display module for displaying the readable information.

8. The data bus monitoring and controlling system as claimed in claim 1, further comprising a storing module for storing the readable information.

9. A data bus monitoring and controlling method comprising:
reading information from a data bus interconnecting a controlling unit and a video/audio unit; and translating the information read from the data bus into readable information.

10. The data bus monitoring and controlling method as claimed in claim 9, wherein the readable information is a human oriented language.

11. The data bus monitoring and controlling method as claimed in claim 9, further comprising:
receiving an input command;
converting the input command into a controlling command in a predetermined format; and
transmitting the controlling command to the data bus to control the video/audio unit.

12. The data bus monitoring and controlling method as claimed in claim 9, further comprising:
connecting an output port to the data bus;
generating time-sequences suitable for being transmitted by the output port, based on the controlling command; and
driving the output port to output the time-sequences.

13. The data bus monitoring and controlling method as claimed in claim 9, further comprising:
displaying the readable information.

14. The data bus monitoring and controlling method as claimed in claim 9, further comprising:
storing the readable information.

15. A data bus monitoring and controlling method comprising:
receiving information from a data bus interconnecting a controlling unit and a video/audio unit, the received information including first controlling commands transmitted from the controlling unit to the video/audio unit, and status information transmitted from the video/audio unit to the controlling unit; and
translating the received information into readable information.

16. The data bus monitoring and controlling method as claimed in claim 15, wherein the received information is machinery codes, the readable information is human oriented language.

17. A data bus monitoring and controlling method comprising:
receiving an input command which activates the receiving.

18. The data bus monitoring and controlling method as claimed in claim 15, further comprising:
sending second controlling commands to the data bus to control the video/audio unit.

19. The data bus monitoring and controlling method as claimed in claim 18, further comprising a step of:
the second controlling commands is identical to the first commands.

20. The data bus monitoring and controlling method as claimed in claim 19, further comprising:
receiving an input command; and
converting the input command into the second controlling command.
